(19) United States
(12) Patent Application Publication
(10) Pub. No.: US 2009/0191519 A1
(43) Pub. Date: Jul. 30, 2009

(54) ONLINE AND COMPUTER-BASED INTERACTIVE IMMERSIVE SYSTEM FOR LANGUAGE TRAINING, ENTERTAINMENT AND SOCIAL NETWORKING

(76) Inventors: Carl I. Wakamoto, Tarzana, CA (US); Shin Muroi, Tarzana, CA (US)

Correspondence Address: DAVID S. NAGY, 756 S. GRIFFITH PARK DR., BURBANK, CA, 91506, US

(21) Appl. No.: 12/163,447

(22) Filed: Jun. 27, 2008

Related U.S. Application Data
(63) Continuation-in-part of application No. 12/016,995, filed on Jan. 18, 2008, now abandoned.
Application No. 12/016,995 is a continuation of application No. 11/021,853, filed on Dec. 23, 2004, now abandoned.

(51) Int. Cl. G09B 19/06; G09B 5/06

(52) U.S. Cl. 434/157; 434/169; 434/319

(57) ABSTRACT

This invention is an apparatus and a method for language training and general entertainment and role-playing. It employs a computer that can play back audio or audio-visual program material, using special software to selectively direct the audio of this playback through the computer's speaker system or through a headset, with the user taking the audio routed to her headset—in particular speech—as a model and prompt to repeat this speech audibly. The user plays the role of the person in the program material whose speech is being routed to her headset, and the special software further permits the user to record her dubbing efforts along with the program material, producing a version of the program material with the user's voice recorded in place of, or in conjunction with, the voice of a character in the program material.

### CROSS-REFERENCE TO RELATED APPLICATION

This application is a Continuation-in-Part of co-pending application Ser. No. 12/016,995, itself a Continuation of application Ser. No. 11/021,853 by the same inventor, and the disclosures of both are hereby incorporated by reference.

### BRIEF SUMMARY OF THE INVENTION

This invention is a system and a method for interactive immersive language training and general entertainment and role-playing. It can provide an enhanced, instructive and entertaining online TV interactive immersive user experience for people from all walks of life, and to the multi-millions of deaf and hard-of-hearing (DHH) and language and English-as-a-second-language (ESL) learners worldwide. It involves using a computer to access a website incorporating a unique player that can play back audio or audio-visual program material, using special software to selectively direct the audio of this playback to a normal, generally-audible sound system or a second sound system that is particularly audible only to a user, such as a headset, with the user taking the audio routed to her headset—in particular speech—as a model and prompt to repeat this speech audibly. Ideally, the user finds herself playing or dubbing the role of the person in the program material whose speech is being routed to the user's headset, and the special software further permits the user to record her dubbing efforts along with the program material, producing a version of the program material with the user's voice recorded in place of, or in conjunction with, the voice of a character in the program material. There has been a recent proliferation of “kids' pages” on the web sites of government and business organizations—the sites of the CIA and FBI are two examples—and this invention, both in its basic embodiment and with game-playing variations mentioned below, is attractively applicable to such sites.

### BRIEF DESCRIPTION OF THE DRAWINGS

FIG. 1 shows a user (U) practicing the invention, wearing a headset (HS) with a headphone (HP) on one ear, a microphone (M) to pick up his utterances, a headset cord (HSC) connecting the headset to the computer (C), which is displaying program material on its screen and playing its audio through speakers (S). Various mouse-clickable software control buttons (B1-4) are shown, along with a screen-mounted camera or webcam (W) and over-the-shoulder-shooting video camera (VC).

FIG. 2 shows a computer screen displaying program material, with four mouse-clickable software control buttons—B1, B2, B3 and B4—shown at the bottom of the screen.

FIG. 3 shows a headset (HS) with a headphone (HP) for one ear, a microphone (M) and a headset cord (HSC) to connect the headset to the computer, as well as an alternative microphone (M) and headphone (HP) combination, either connected by headphone cord (HPC) and headset cord (HSC) or wirelessly.

FIG. 4 shows the Karamedia® player playing audio-visual program material (6), with control buttons below: Stop (1), Play/Pause (2), Volume (3), Playback Speed (4) and Toggle Control for the Karamedia® effect (5). One can selectively view a running transcript of the dialog (12). A search box (13) and button (14) allow searching the text of the transcripts of the program material for key words or phrases. Buttons along the sides (7) allow accessing other program material, and additional buttons allow recording the user's performance (20), marking the beginning of a particular segment (SB) of the program material, marking the end of the segment (SE), and playing back the thus-marked segment (SP).

FIG. 5 shows another version of the Karamedia® player, with Play/Pause (2), Stop (1) and Scan and Skip Controls (8), plus Karamedia® slow-speed (9) and regular-speed (10) controls and a link to a word game (11) incorporating vocabulary words from the program material. A search box (13) and button (14) allow searching the text of the transcripts of the program material for key words or phrases. A button (15) starts and stops background music, and a fader (17) increases or decreases its volume. Another fader (3) increases or decreases the volume of the program material, and a button (20) allows recording of the user's performance.

FIG. 6 shows a program material file-exchange scheme, showing Subscriber 1 (S1), Subscriber 2 (S2), the Target Site (TS) and Off-Line Storage (OLS), and how files can be accessed by one from another.

FIG. 7 shows an alternative website size-minimizing file-exchange scheme, showing Subscriber 1 (S1), Subscriber 2 (S2), the Target Site (TS) and Off-Line Storage (OLS), and how large video files can be accessed by one from another with the solid lines, while small password and instruction files and customized media players are shown passing via dashed lines.

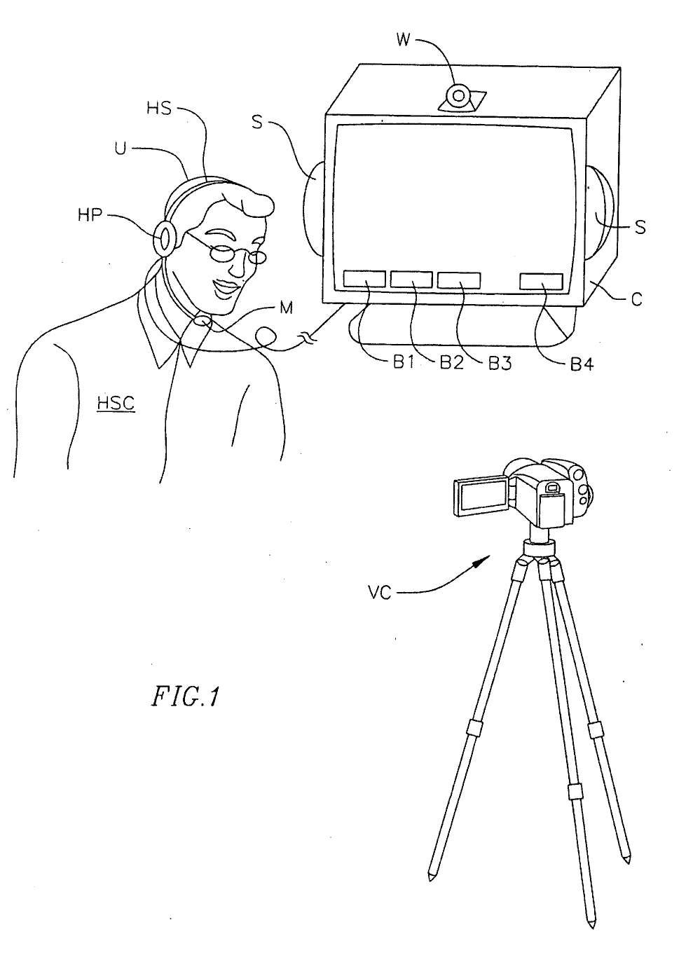

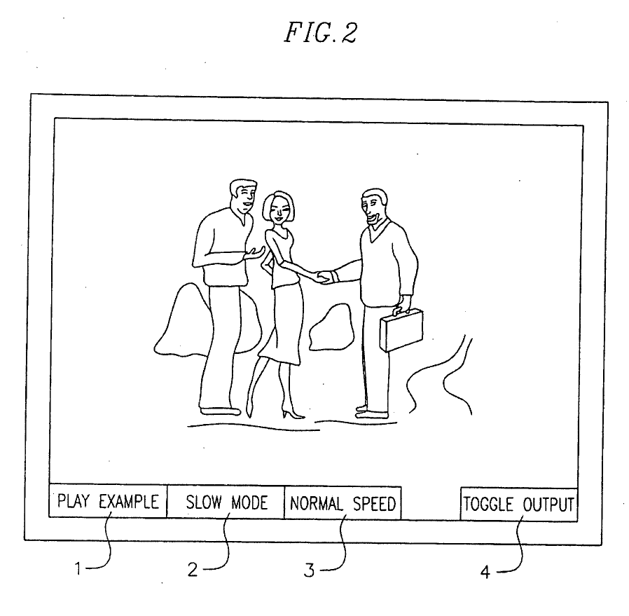

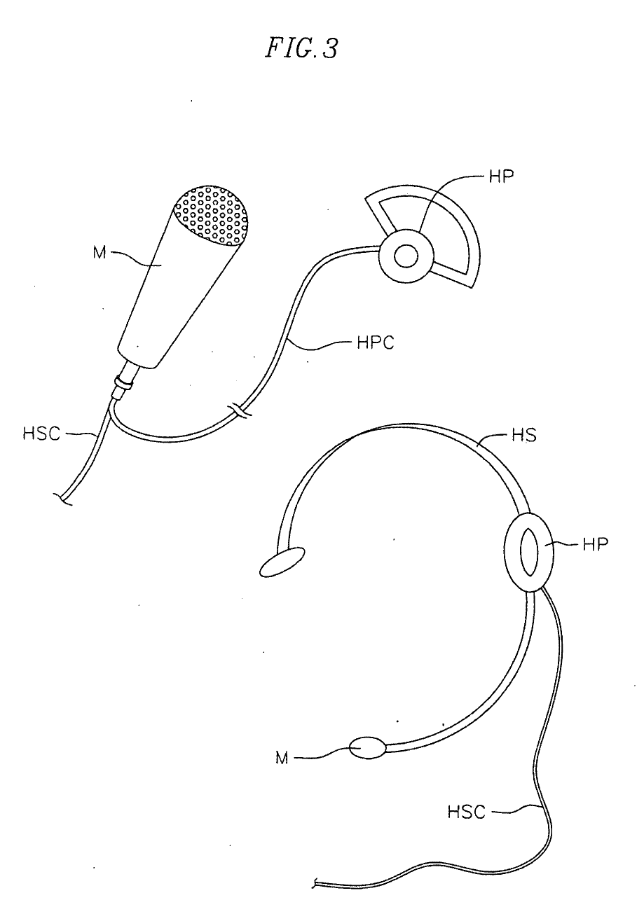

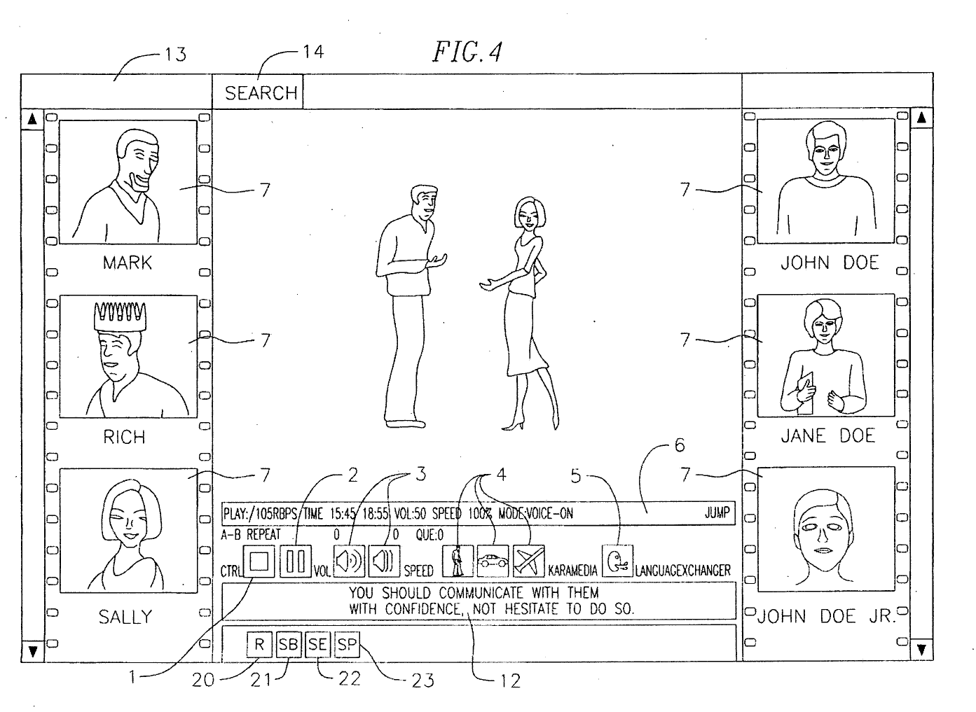

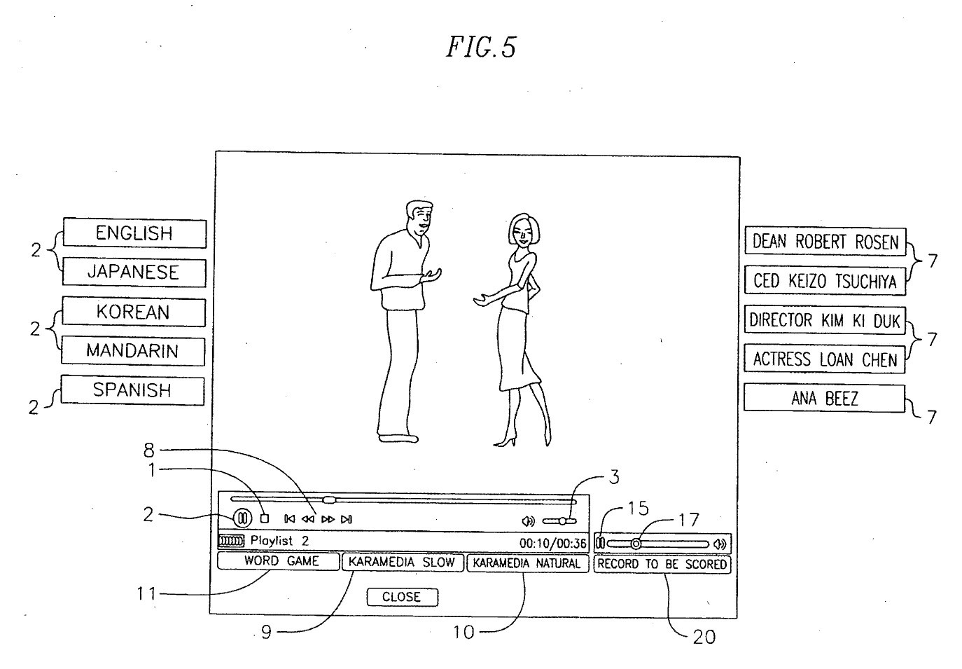

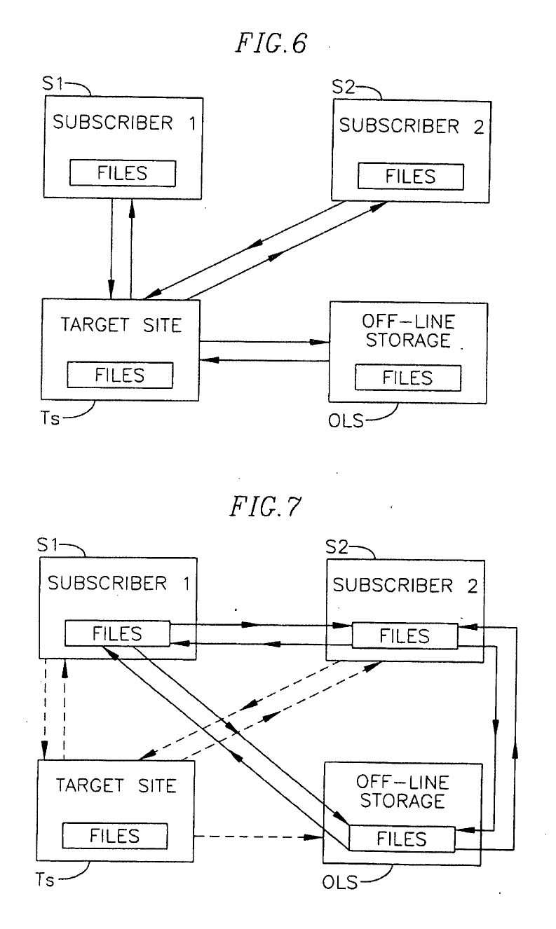

### DETAILED DESCRIPTION OF THE INVENTION

This invention, like the inventor's co-pending invention of which this is a C.I.P., addresses the problem of how to make language teaching and training more entertaining and attractive as a process, and does so in a way that is sufficiently entertaining so as to be attractive even without a foreign-language component. This is a development of the inventor's prior invention, enhanced with the application of special software to make the invention particularly easily distributable and practicable. As envisioned, this invention could be easily used in conjunction with any program material available in digital form, on the internet or elsewhere, in particular and most innovatively with program material resident on the user's own computer.

This invention involves a further embodiment of the inventor's Karamedia® process function of routing particular audio to the user's headset and other audio to generally-audible speakers. It comprises using a computer and/or an audio-video player on a website to play program material, such as audio dialog or a song, or an interview or a movie or TV or video of whatever source, in a language the user wants to learn—in the educational application—or that contains a character or role the user would like to play—in the entertainment application. Special software, the code for an example of which appears below, is used to direct the audio either to the computer's regular speaker system or to a headset (or some other second speaker system that is particularly audible only to the user), or optionally to both. The user controls this selection of the audio output through a variety of means, for example through on-screen clickable buttons, or hotkeys on a keyboard, permitting toggling back and forth between speakers and headset—this can also be accomplished through the use of a more traditional switching device, optimally a hand-held toggling controller, for example using A/B switches or a toggle switch; this hand-held switch could optionally employ wireless technology. The user chooses a character in the source material that she desires to “play”, and when that character speaks in the source material, then she directs his speech to play into her headset, thereby prompting her to repeat it audibly as it plays in her ear. When his dialog ends, she switches the audio back to the computer's regular sound system, hearing the other dialog in the source material from a greater distance, just as in a normal conversation—to this end, the headset ideally is a mono unit with a speaker for only one ear, or else a stereo unit with one speaker worn off the ear. In addition, the headset can have a microphone, and the software can permit the recording of the user's dialog, optionally in conjunction with the program material, to give the user a reviewable record of her efforts. In the case of audio-visual material, this can be done either with the user's dialog overdubbed into the original video, or with the user's performance recorded audio-visually and displayed together with the original program material in split screen, picture-in-picture, or some other juxtaposition such as having the user's performance captured from over her shoulder, showing both her, performing somewhat in profile, and the screen with the program material. A further wrinkle in this process can be the capability of the special software to control and vary the speed of playback of whatever media program is used to play back the program material.

This process of dubbing the dialog of a character in the voice of the user proves to be both highly instructive and entertaining—so entertaining, in fact, that is an enjoyable pursuit even absent the original instructive intent. It can be turned into a game through a variation by which one directs the audio selectively to the headsets of multiple users, with the various users audibly playing out the dialog of the characters onscreen. Recording the results along with the video of the program material allows the users to see how well—or poorly—each did in delivering the performances of the characters for whom they were dubbing dialog. In addition, adding the visual recording of the user's efforts permits the keeping of a record to track progress, and allows users to share their performances with others on file-sharing and social websites.

This invention is practiced with a regular personal computer. The user can employ program material present on a specific website (“the target site”), use program material already resident on her own computer, or she could use other program material on another website such as YouTube®, or link it to the target site. The Karamedia® player and special software could be present either on the target site or the user's computer. The Karamedia® player presents clickable buttons onscreen which permit the directing of audio output to one of a plurality of outputs, one of which would connect to the computer's sound system, and another to a headset. The headset would also have the microphone typical of common computer headsets, and the user would hear the selected dialog through the headset and speak it back into the microphone. The Karamedia® player would permit the recording of this repeated speech, and the user would review it to check her accuracy.

The Karamedia® player has, incorporated into it, programming that manipulates parameters in the audio/video player utilized (e.g., Flash®, QuickTime®, Windows Media®, etc.) so as to alter the Audio Balance default setting to direct the audio from the selected program material to be directed to the a specific channel. It can easily be understood that, with the increasing profusion of multi-channel audio formats—stereo, stereo plus center channel, 5.1, 6.1, 7.1, etc.—there can be a number of channels toward which to direct the audio signal; for the sake of simplicity and comprehension, and without suggesting any limitation, this description will have the audio directed to the left channel.

Karamedia® player also has, incorporated into it, programming that manipulates parameters in the audio/video player utilized to alter the Speed or Rate parameter so as to permit the selection of reduced speed (what, in conjunction with video, would be called slow-motion). If the dialog is too difficult for the user to repeat at the original speed, she could avail herself of the speed-control capability of the Karamedia® player and play the program material back at a slower speed, thereby allowing her to literally get up to speed.

Furthermore, the Karamedia® player can incorporate a “comparison” or “rating” function, which would compare the user's performance to the original dialog and assign a rating or grade, reflecting the accuracy of the user's performance. This could be done “manually”, by providing the service of having a person actually compare and evaluate the user's performance. A preferred alternative, however, would be to accomplish this near-instantaneously through the use of voice-recognition software, which could adapted to provide transcripts of both the original dialog and the user's performance. These documents would then be compared, in a manner similar to the “tracking” or “red-lining” functions of word-processing software, with the differences between the documents being totaled and generating a grade. This grade could be the number of “errors” or deviations, or that number weighted against the number of words in the entire dialog, or some other method could be employed. In a preferred embodiment, one could use that weighted number to generate an expression of the percentage of the performance that was correct, encouraging the user to strive for a score of 100.

In a further variation, the Karamedia® player would contain a link to a page displaying such a transcript of the original dialog, as an aid for matching aural recognition of a language with reading. Such a page could further contain a vocabulary list to aid a user utilizing the invention for language study. The Karamedia® player could further contain a link to a game page specially adapted to each program material clip, and employing just such a vocabulary list as fodder for a “hangman” or crossword or other word game. A preferred embodiment features an on-line “hangman” game that randomly selects a vocabulary word and delivers a hint or clue. Play proceeds as in the normal pen-and-paper version of the game, although a preferred variation incorporates a count-down timer for each “guess” or “turn”, giving the user a limited period of time, e.g., ten seconds, in which to select another letter or forfeit the turn and suffer the addition of another limb on the hangman. Furthermore, the number of wrong guesses (and forfeits) can be combined with the amount of time used to generate a score for the user. To aid in selecting words or subject matter for the playing of such games, the Karamedia® player can incorporate a “search” function that can search the transcripts for a specific word or words. It can easily be seen how such a game can make learning fun and spark greater exposure to and interest in foreign languages.

While most ordinary home computers lack the specific left and right channel outputs discussed earlier, a relatively simple implementation involves using a splitter adapter inserted into the regular speaker output present on all modern personal computers. The splitter adapter would split the signal into left and right channel outputs, and the feeds to the speakers and headset could each be connected to one channel, for the sake of easy reference say headset to left, and speakers to right. With the mini-phone jacks and plugs normally employed with personal computers, inserting a stereo speaker plug into a mono splitter jack will normally result in only the left speaker in a typical stereo pair getting a signal, but this can be corrected by having a stereo-to-mono adapter inserted between the speaker plug and the right channel of the splitter adapter. Similarly, if a stereo headset is plugged in in such a manner only its left unit will get a signal which, given the fact that one only listens to one headphone speaker in practicing this invention, actually works out perfectly. When the program material is playing dialog that the user does not wish to recite, the software is set to route the audio to the right channel, and thus to the speakers; when the dialog that the user wants to “play” commences, the user clicks the appropriate control (or presses the appropriate “hot-key”) to route the audio to the left channel, and thus to the headset. The headset's microphone is be connected to its normal input on the computer.

In a particularly useful embodiment, in computers with separate speaker and headphone jacks, the software would route the program material's audio selectably to the speaker or headphone jacks, and would convert, as needed, mono audio signals to be directed to both speaker channels and stereo audio signals to mono for the headset. In laptop computers, which typically contain internal speakers, the software would perform the same function in routing signals selectably to the internal speakers or the headphone jack. It must be mentioned that there are computers wherein the routing of audio signals to internal speakers vs. to headphone jacks is hardware-controlled, e.g., where the insertion of a headphone plug into the headphone jack physically interrupts the connection to internal speakers or speaker outputs, and such computers would need to be modified in order for this function to be software-controllable. A key point is that this invention can take audio from a single source or channel and achieve the Karamedia® function of routing particular audio to the user's headset and other audio to speakers without needing to “treat” or edit or re-record the audio first.

A further enhancement of this invention is to provide, optimally on the target site, a selection of background music and sound effects that can be selected to be combined with the program material. With program material consisting of an interview or other monolog (or which is simply unusually “dry”), it is an enhancement to the experience of practicing this invention to add some sort of selectable background music or other effect, which is routed to one or more of the speakers. Having background music or effects playing continuously through the speakers while the program materials's dialog is toggled back and forth between the speakers and the headset is very effective in creating the sense that the user is stepping into the scene she is playing.

Additionally, the player, through the use of time-code recognition or other means, allows the user to “tag” both a start and an end point in a piece of program material, so that just a desired segment of a given program may be played and, optionally, repeated or looped. The player and software can also incorporate the ability to vary the strength of the signals going to the speakers and headset and coming from the microphone, so as to permit the balancing of those levels.

The audio-video player control capability bundled into this invention makes possible its use as a customized “skin”, with its controls manipulating a known player, such as Windows Media Player, Flash Player or Apple Quick-Time, as well as controls to permit using the invention to control the speed of playback, playing word games, and furnishing transcripts.

The video clips used—both the program material and also videos of the users “performing” it—can, with the aid of this invention, become staples of language exchange forums/communities.

In an especially effective and efficient embodiment, this invention would be practiced on the internet A web site (the “target site”) could contain an array of program material and a video player incorporating the invention, and users could access the site, download such a player and play program material streamed to their computers.

In a further development, to minimize size and capacity needed for the web site, the program material could be resident in other, off-line locations, such as an off-line storage server operated by the web site, or on the users' own computers. In this latter variant, the user would give the web site identifying information for the user's computer and the file path of the file on the user's computer containing the program material. The web site would incorporate this information into a customized video player that would be downloaded to the user's computer and would play that specific program material file. Users could make files on their own computers accessible to other users, and video players could be similarly be customized to permit one user to download and play the program material resident on another user's computer; program material on other computers could be accessed similarly. In this way, the web site itself would only be a conduit for the small video player files, rather than the large audio-visual program material files, which would move directly from one computer to another, thus permitting a streamlined web site with just thumbnail listings of the available program material and links, rather than the entire program material files.

### DESCRIPTION OF THE PREFERRED EMBODIMENT

The ability of this invention to employ program material from a remote location is especially helpful in the preferred embodiment. The Karamedia® player is incorporated into a website, the “target site” as mentioned earlier, on a web page. The user would register with the target site to become a member or subscriber, and would then submit the file path of program material, residing in her own computer, to the target site (alternatively, she can submit the URL of program material on the internet, or the program material can be incorporated on the target site in the more traditional manner). The target site accesses this program material and enables the Karamedia® player to play it back on the user's computer (having the program material reside off-site very advantageously diminishes the server-capacity requirements of the target site). Subscribers would be encouraged to record their performances, as described in greater detail below, and either post them on the target site or post the file path of the recorded performance identifying where the recording resides on the subscriber's computer—they would be similarly encouraged to share their own program material for sharing with other subscribers. As a community of subscribers arises, there would be an increasing multitude of program material choices available to subscribers.

In order to keep the web server requirements to a minimum, the number of program material and performance clips kept on the web site could be kept to a minimum, e.g., a “Top 10” of each, with all the rest being accessible from an off-line storage site.

The Karamedia® player permits the user to select a portion (or all) of the program material to play, the speed at which to play the program material, and background music or other effect. The user clicks on the controls of the Karamedia® player to select when to direct the program material audio to her headset, when to her computer's speakers, and to toggle between the two. Prompted by the audio routed to her headset, the user repeats it, attempting to synchronize her voice with the prompt (and thereby with the video component of the program material). The user's vocalizing is picked up by the headset's microphone and the recorded by the Karamedia® player, as is the user herself with the use of a video camera. When the user is done with reciting/recording, she can hear and see her performance played back, to judge how well she carried out her task. Using a screen-mounted video camera pointed at the user, such as are frequently found on laptop computers, the player and software would play the user's performance back in a split-screen or picture-in-picture format, with the user's performance next to the original program video; a camera mounted off near one of the user's shoulders could advantageously capture both the user's performance and the program material on-screen, and wouldn't require a split screen. The finished, “combined” recording, which can frequently be poignant, impressive, funny or all three, can be saved, and shared with others on sites like “YouTube” or other social networks, or used in blogs.

In a further variation involving a screen-mounted camera, the user can have a “cancelable” background behind her—this is normally a solid-colored background, often green or blue, referred to in the motion-picture industry as “green screen” or “blue screen”. Assuming the use of a green screen, that color can be “canceled” from the picture, leaving only what is not green—the user can wear green clothing to cover parts of her body, as well, and could, for example, leave only her head visible. Thus, the user could video-record her performance, and then superimpose her own image onto the program material. Most advantageously, the user could superimpose her image over the image of the character whose dialog she was performing, even in real time, i.e., as she was delivering the performance. With a joy-stick or other controls, the user could place her image and orient her head and/or body so as to copy the movements of the character and try to “replace” that character on screen as perfectly as possible. It can readily be seen that this could turn into an amusing pastime, and users could record their superimposed performances to enjoy and share with others.

The special software code shown below is adapted to Microsoft's Windows Media Player; it is understood that it can be similarly adapted to control other commonly-used media players. This particular code plays back a Japanese-language clip in the slow Karamedia mode.

I claim:

1. An apparatus for entertainment and learning languages, comprising:
a computer system, including a keyboard or other access device, and a first, generally audible sound system;
a headset or other second sound system designed to be particularly audible only to a user;
program material comprising audio information on a single channel which is accessible to and playable by said computer system via a media player program; and
a software program accessible by said computer system that permits the user to selectively direct the audio output of said program material, when accessed and played, to the first or second sound system.

2. The apparatus of claim 1, wherein said computer system also comprises a video monitor, and wherein said program material is audio-visual.

3. The apparatus of claim 2, wherein said headset or other second sound system further comprises a microphone, and said software program is further capable of recording of sound uttered into said microphone, selectively along with and in response to the audio or video or both of said program material.

4. The apparatus of claim 1, wherein said software program can selectively control said media program so as to change the speed of playback of program material.

5. The apparatus of claim 1, wherein said software program further can access additional audio program material that is playable through said first, generally audible sound system.

6. The apparatus of claim 3, further comprising a video camera capable of recording, and said software program further comprising capability to record, the user's performance of said sound uttered into said microphone;
and said software program further comprising capability to store said audio and video recording of the user's performance of said sound uttered into said microphone, and to play back said recording through said monitor and at least said first, generally audible sound system.

7. The apparatus of claim 1, wherein said software program permits the marking of said program material so as to access and play just a selectable portion of said program material.

8. The apparatus of claim 1, wherein said program material resides in said computer system, and said software system resides on a website, and said computer system and said website communicate with and access each other via the internet.

9. The apparatus of claim 6, wherein said software program further can selectively control said media program so as to change the speed of playback of program material;
wherein said software program further can access additional audio program material that is playable through said first, generally audible sound system;
wherein said software program permits the marking of said program material so as to access and play just a selectable portion of said program material; and
wherein said program material resides in said computer system, and said software system resides on a website, and said computer system and said website communicate with and access each other via the internet.

10. The apparatus of claim 9, wherein said software program further comprises a digital transcript of said program material, and accessing said transcript to generate words used in a word game played with said software program.

11. The apparatus of claim 9, wherein said software program further comprises accessing digital transcripts of audio and audio-visual program material, and searching said transcripts for specific words or phrases, and producing a list of transcripts containing the word or phrase searched for, and choosing a specific transcript from said list, and accessing and playing the program material from which the chosen transcript was transcribed.

12. The apparatus of claim 6, in which the user's performance is recorded against a green screen or other deletable background, and wherein said software program further permits the superimposition of the user's recorded performance, with the background deleted, into the original program material.

13. The apparatus of claim 12, wherein said software program further comprises the capability to continually position and reposition the user's image superimposed on the original program material.

14. The apparatus of claim 1, further comprising a hand-held controller which selectively directs the audio output of said program material.

15. A method of entertainment and language instruction, comprising:
utilizing a computer system, including a keyboard or other access device, and a first, generally audible sound system;
a headset or other second sound system designed to be particularly audible only to a user;
audio program material accessible to and playable by said computer system via a media program; and
playing said program material with a software program accessible by said computer system that permits the user to selectively direct the audio output of said program material, when accessed and played, to the first or second sound system.

16. The method of claim 15, wherein said computer system incorporates a video monitor and said program material is audio-visual and is displayed via said monitor.

17. The method of claim 16, further comprising:
having said second sound system further comprise a microphone;
having said software program further permit the recording of sound uttered into said microphone, selectively along with the audio or video or both of said program material; and
uttering sounds into said microphone and recording it.

18. The method of claim 17, wherein said uttering of sounds is done by a user in an effort to mimic audio selectively directed to said second sound system.

19. The method of claim 15, wherein said software program can selectively control said media program so as to change the speed of playback of program material, and a user changes said playback speed.

20. The method of claim 15, wherein said software program further accesses additional audio program material that is played through said first, generally audible sound system.

21. The method of claim 17, further comprising recording the user's performance of said sound uttered into said microphone with a video camera and said software;
and playing back said recording through said monitor and said first, generally audible sound system.

22. The method of claim 15, wherein said program material resides in said computer system, and said software system resides on a website, and said computer system and said website communicate with and access each other via the internet.

23. The method of claim 21, wherein the user, with the aid of said software program, further selectively controls said media program so as to change the speed of playback of program material;
wherein said software program further can access additional audio program material that is playable through said first, generally audible sound system;
wherein the user, with the aid of said software program, marks said program material so as to access and play just a selectable portion of said program material; and
wherein said program material resides in said computer system, and said software system resides on a website, and said computer system and said website communicate with and access each other via the internet.

24. The method of claim 23, wherein said software program further comprises a digital transcript of said program material, and wherein the user accesses said transcript to generate words used in a word game played with said software program.

25. The method of claim 24, further comprising accessing said digital transcripts of audio and audio-visual program material, and searching said transcripts for specific words or phrases, and producing a list of transcripts containing the word or phrase searched for, and choosing a specific transcript from said list, and accessing and playing the program material from which the chosen transcript was transcribed.

26. The method of claim 15, wherein the selective direction of audio program material is accomplished by means of a hand-held controller.

27. The method of claim 16, further comprising:
having the software program resident on a web site;
having the program material resident on an off-line site;
having a user communicate the location of the program material to the software program on the web site;
having the software program incorporate the location of the off-line program material and custom-adapt a media player program to play said off-line program material;
downloading said custom-adapted media player program to the user's computer; and
playing said off-line program material with said custom-adapted media player program.
